(19) United States
(12) Patent Application Publication
(10) Pub. No.: US 2010/0320880 A1
(43) Pub. Date: Dec. 23, 2010

(54) BRUSHLESS MOTOR

(75) Inventor: Yutaka Kamogi, Tottori (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/526,087

(22) PCT Filed: Jul. 27, 2007
(86) PCT No.: PCT/JP2007/064733

§ 371 Date: Aug. 6, 2009

(30) Foreign Application Priority Data
Mar. 9, 2007 (JP) 2007-059296

(51) Int. Cl. H02K 11/00

(52) U.S. Cl. 310/68 B

(57) ABSTRACT

To provide a small-sized brushless motor in which a rise in the temperature of power elements can be reduced. A stator (2) is disposed on the same axis as an output shaft (1a) of a rotor (1). A first wiring board (3a) on which power elements (7) are mounted is disposed at the ends of the rotor (1) and the stator (2). A second wiring board (3b) is disposed between the rotor (1) and the first wiring board (3a) so as to partition the inside of a motor casing (4). Magnetoelectric conversion elements (5) are disposed on the second wiring board (3b) in close vicinity to the rotor (1). Stator windings (22) are connected to the first wiring board (3a).

### TECHNICAL FIELD

The present invention relates to a brushless motor including a driving circuit. To be specific, the present invention relates to a method of mounting the driving circuit of a motor in the motor operated in a high temperature environment such as the engine room of an automobile.

### BACKGROUND ART

FIGS. 11(a) and 11(b) show a small-sized brushless motor of the prior art. In the brushless motor, a rotor 1, a stator 2, and a wiring board 3 are stored in a motor casing 4. On the wiring board 3, magnetoelectric conversion elements 5, a control circuit 6, and power elements 7 are mounted. The magnetoelectric conversion elements 5 are disposed on the wiring board 3 in close vicinity to the rotor 1. The magnetoelectric conversion elements 5 detect the magnetic pole of the rotor 1, the control circuit 6 switches power to a plurality of stator windings 2a through the power elements 7 to generate a rotating magnetic field, and the rotor 1 is rotationally driven.

FIG. 12 shows a large-sized motor. In the brushless motor of patent document 1, a wiring board 8 on which a control circuit is mounted is attached at the center of the inside of a circuit protective case 9. Power elements 11 driven by the wiring board 8 to switch power to motor windings 10 are attached to an outer wall 12 of the circuit protective case 9 and dissipate heat.

Further, the power elements 11 and the wiring board 8 on which the control circuit is mounted are protected by the circuit protective case 9 from the influence of heat generated from the motor windings 10.

Patent document 1: Japanese Patent Laid-Open No. 2000-4566

### DISCLOSURE OF THE INVENTION

### Problems to be Solved by the Invention

When the small-sized motor including a driving circuit is operated in a high-temperature environment exceeding 100° C., the stator windings 2a generate heat and the influence of the radiation and convection of the heat from the stator windings 2a may increase a temperature to about 130° C. around the power elements 7. However, the upper limit of a junction temperature at which a typical power element is operable is 150° C. and thus it is necessary to reduce heat generation from the power elements 7 and a rise in temperature around the power elements 7 to increase reliability.

However, unlike in a large-sized motor, the circuit protective case 9 cannot be used in a small-sized motor as a device for protection from the influence of heat generated from a heat sink and the motor windings 10.

An object of the present invention is to provide a small-sized brushless motor in which a rise in temperature around power elements can be reduced.

### Means for Solving the Problems

A brushless motor according to claim 1 in which the magnetic pole of a rotor is detected by magnetoelectric conversion elements disposed on detection positions on a fixation side relative to the rotor, a control circuit switches power to a plurality of windings of a stator through power elements based on the detection to generate a rotating magnetic field, and the rotor is rotationally driven, wherein the stator is disposed on the same axis as the output shaft of the rotor, a first wiring board, on which at least the power elements are mounted out of the control circuit and the power elements, is disposed so as to be opposed to the opposite end of the output shaft of the rotor, a second wiring board is disposed between the rotor and the first wiring board so as to partition the inside of a motor casing, at least the magnetoelectric conversion elements out of the control circuit and the magnetoelectric conversion elements are disposed on the second wiring board in close vicinity to the rotor, and the stator windings are connected to the first wiring board.

A brushless motor according to claim 2 of the present invention, in claim 1, wherein the control circuit is mounted on a surface of the first wiring board so as to face the second wiring board, and the power elements are mounted on the opposite surface of the first wiring board from the surface facing the second wiring board.

A brushless motor according to claim 3 of the present invention, in claim 1, wherein the first wiring board has a conductor disposed on a surface on which the power elements are mounted, and the conductor is larger in thickness than a conductor on a surface of the second wiring board, the surface having the magnetoelectric conversion elements mounted thereon.

A brushless motor according to claim 4 of the present invention, in claim 1, further including guide grooves formed on the outer periphery of the second wiring board, the guide grooves allowing the passage of leads of the stator windings connected to the first wiring board from the stator.

A brushless motor according to claim 5 of the present invention, in claim 1, further including notches formed on parts of the outer peripheries of the first and second wiring boards, and spacers fit between the notches of the first wiring board and the inner periphery of the motor casing to keep a clearance between the first wiring board and the second wiring board, the wiring boards being electrically connected to each other via electrode pieces passing through the spacers.

### ADVANTAGE OF THE INVENTION

With this configuration, the second wiring board is disposed between the rotor and the first wiring board so as to partition the inside of the motor casing. Thus the second wiring board interrupts the radiation and convection of heat from the stator windings, thereby reducing a rise in temperature around the first wiring board and a rise in temperature around the power elements mounted on the first wiring board.

### BRIEF DESCRIPTION OF THE DRAWINGS

FIG. 1 shows a longitudinal sectional view and a transverse sectional view of a brushless motor of the present invention;

FIG. 2 shows a partially cut perspective view according to an embodiment;

FIG. 3 shows an exploded perspective view according to the embodiment;

FIG. 4 is a sectional view taken along line B-BB of FIG. 1(b);

FIG. 5 shows a top view and a bottom view of a first wiring board and a top view and a bottom view of a second wiring board according to the embodiment;

FIG. 6 shows a front view, a rear view, and a sectional view of the first and second wiring boards connected via spacers according to the embodiment;

FIG. 7 shows a front view and a bottom view of a motor casing body and a front view of a casing lid according to the embodiment;

FIG. 8 shows a plan view of the casing lid according to the embodiment;

FIG. 9 shows a front view and a bottom view of a motor casing body and a front view of a casing lid according to another embodiment;

FIG. 10 shows a longitudinal sectional view of an outer rotor type;

FIG. 11 shows a longitudinal sectional view and a transverse sectional view of a small-sized motor according to the prior art; and

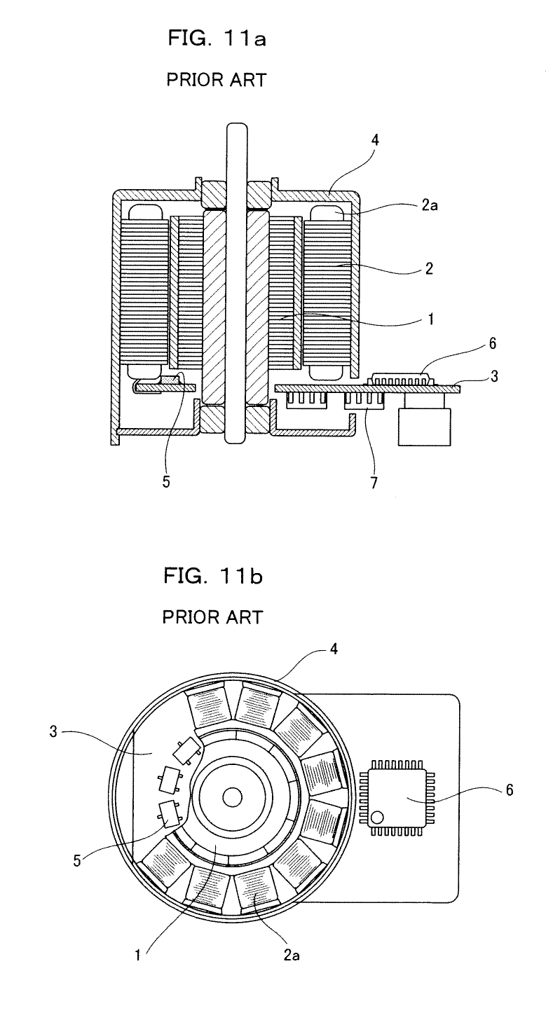

FIG. 12 shows a sectional view of a large-sized motor according to the prior art.

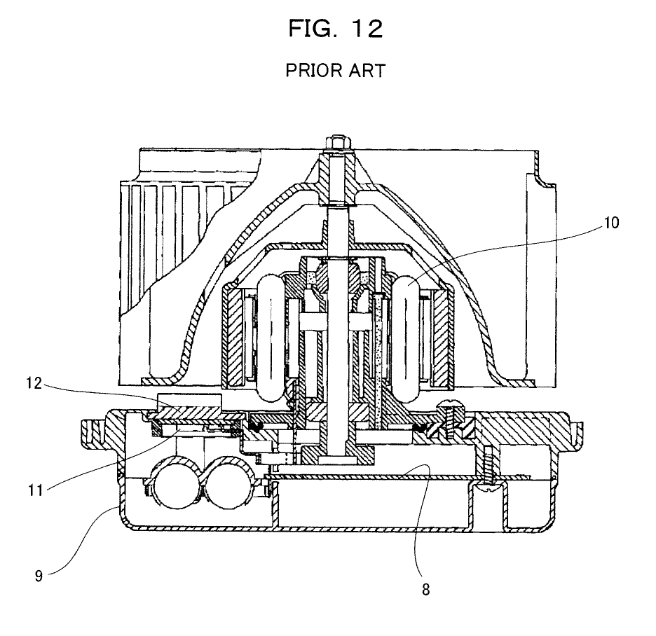

### BEST MODE FOR CARRYING OUT THE INVENTION

A brushless motor of the present invention will be described below according to the following embodiments.

### First Embodiment

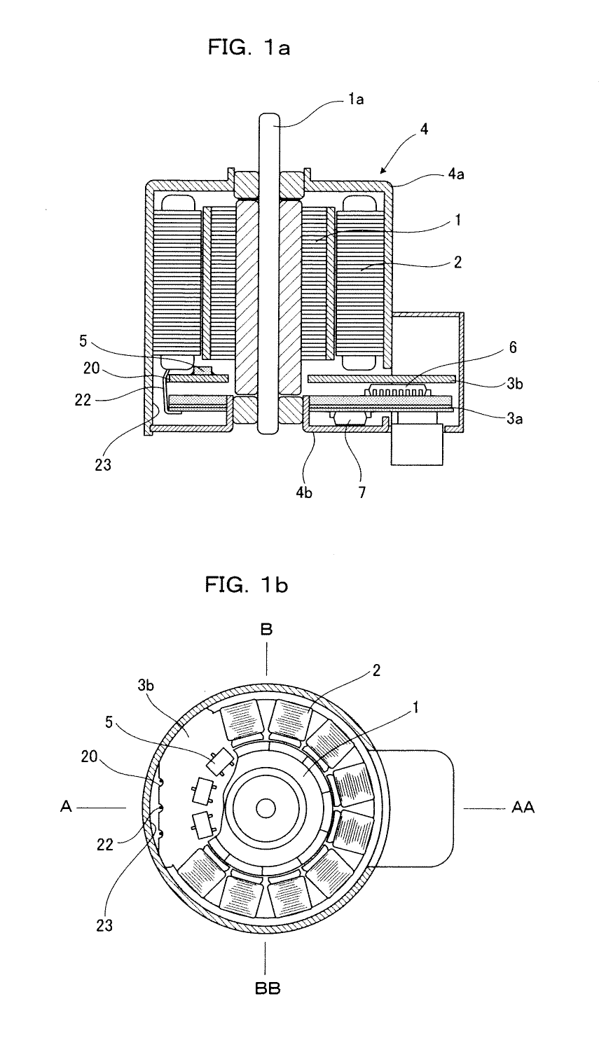

FIGS. 1(a) and 1(b) to 8 show (First Embodiment) of the present invention.

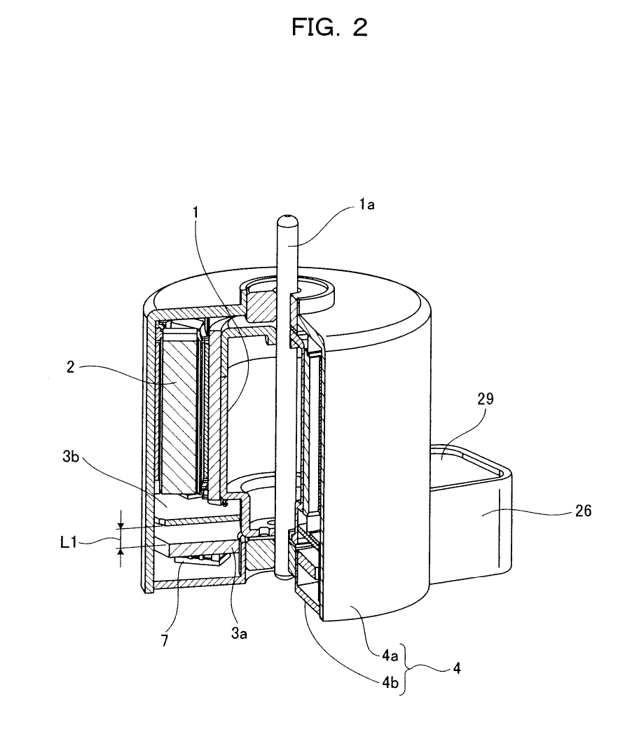

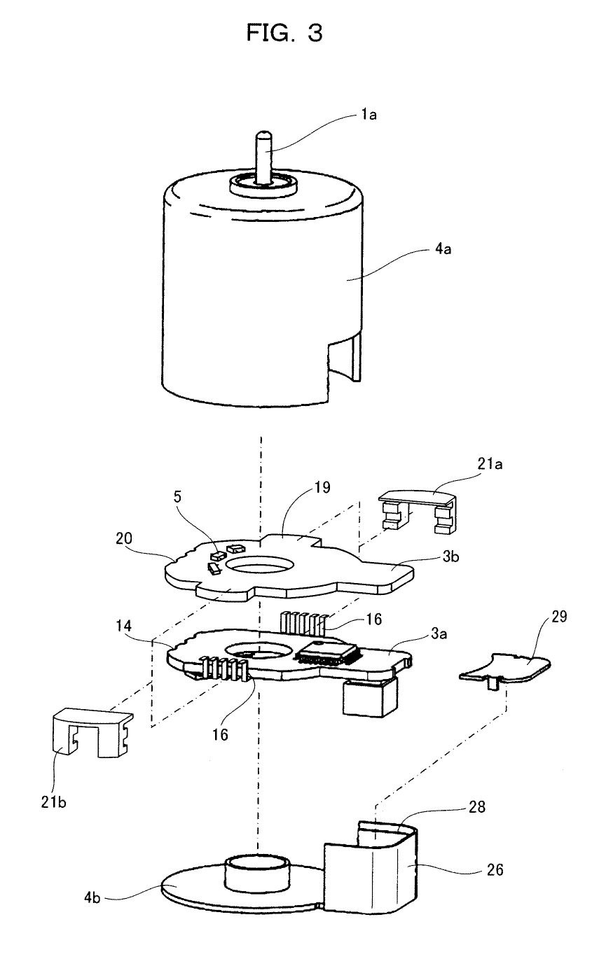

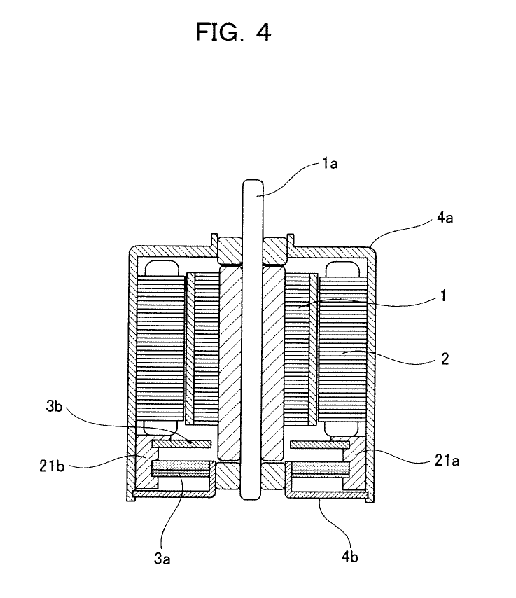

The brushless motor of FIG. 1(a) is a sectional view taken along line A-AA of FIG. 1(b). FIG. 2 is a perspective view of a completed product, FIG. 3 is an exploded perspective view, and FIG. 4 is a sectional view taken along line B-BB of FIG. 1(b).

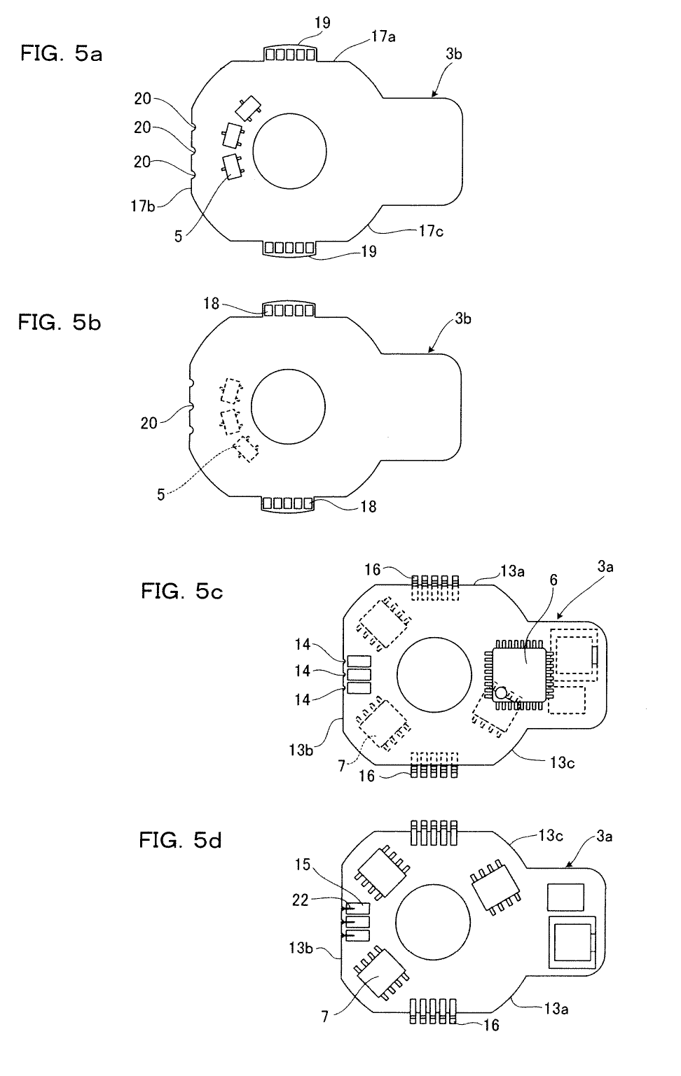

A motor casing 4 is made up of a metallic casing body 4a and a metallic casing lid 4b. In the motor casing formed of the casing body 4a and the casing lid 4b, a rotor 1, a stator 2, and parts of first and second wiring boards 3a and 3b are stored. The stator 2 is disposed on the same axis as an output shaft 1a of the rotor 1. The first wiring board 3a is disposed at the opposite end of the output shaft 1a of the rotor 1 from the rotor 1 and the stator 2. On the first wiring board 3a, a control circuit 6 and power elements 7 are mounted. FIGS. 5(c) and 5(d) show the top surface and the undersurface of the first wiring board 3a. The first wiring board 3a has outer parts 13a, 13b, and 13c which are linearly cut so as to be separated from the inner wall of the casing body 4a.

The outer part 13b disposed between the linearly cut outer parts 13a and 13c of the first wiring board 3a have guide grooves 14 formed thereon. On the undersurface of the first wiring board 3a, lands 15 are provided in close vicinity to the guide grooves 14.

On the outer parts 13a and 13c of the first wiring board 3a, the proximal ends of electrode pieces 16 extended to the second wiring board 3b are secured and are electrically connected by soldering.

For further dissipation of heat generated from the power elements 7, the first wiring board 3a has copper foil on the undersurface where the power elements 7 are mounted and the copper foil is at least twice as thick as ordinary copper foil having a thickness of 18 μm or 35 μm. For example, a double-sided wiring board may be used where copper foil is 105 μm in thickness on both surfaces. Alternatively, a double-sided wiring board may be used where copper foil is at least 105 μm in thickness on the undersurface and is thicker than copper foil on the top surface.

The second wiring board 3b on which magnetoelectric conversion elements 5 are mounted is disposed between the rotor 1 and the first wiring board 3a. To be specific, the second wiring board 3b between the rotor 1 and the first wiring board 3a is disposed so as to partition the inside of the motor casing 4 with a clearance L1 from the first wiring board 3a. The magnetoelectric conversion elements 5 are disposed in close vicinity to the rotor 1. FIGS. 5(a) and 5(b) show the top surface and the undersurface of the second wiring board 3b.

The second wiring board 3b has outer parts 17a, 17b, and 17c which are linearly cut so as to be separated from the inner wall of the casing body 4a according to the outer parts 13a, 13b, and 13c of the first wiring board 3a. On the outer parts 17a and 17c, terminal portions 19 are formed in a protruding manner. The terminal portions 19 have lands 18 coming into contact with the ends of the electrode pieces 16 soldered to the first wiring board 3a. Further, the outer part 17b of the second wiring board 3b has guide grooves 20 formed as on the first wiring board 3a.

The second wiring board 3b is a double-sided wiring board where copper foil has a thickness of, for example, 18 μm or 35 μm on the top surface and the undersurface.

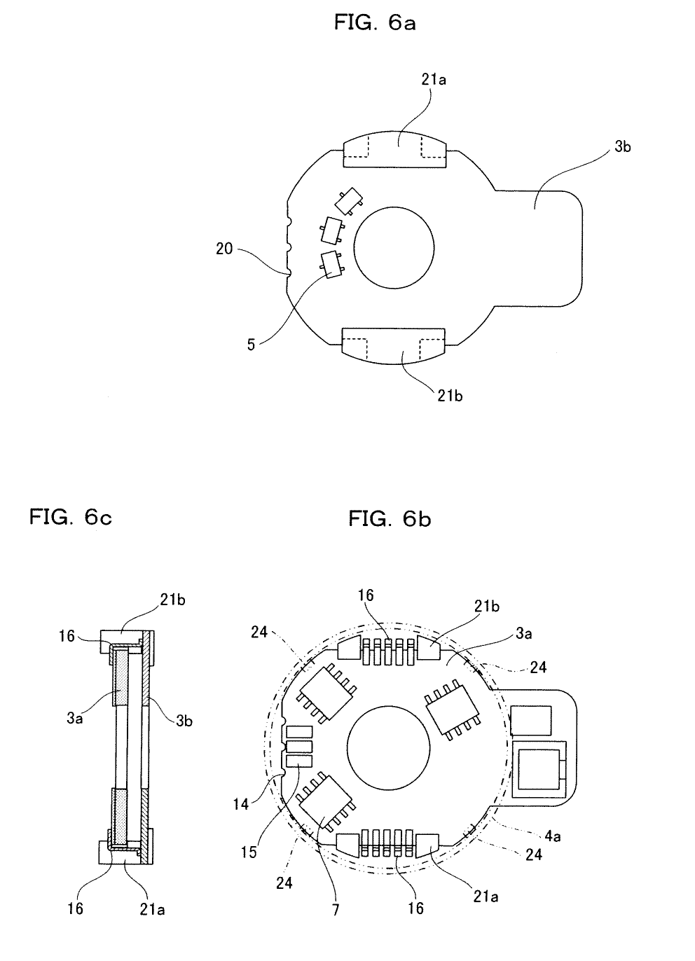

As shown in FIGS. 4, 6(a), 6(b), and 6(c), the first and second wiring boards 3a and 3b have an electrically insulating spacer 21a set between the outer part 13a of the first wiring board 3a and the outer part 17a of the second wiring board 3b and an electrically insulating spacer 21b set between the outer part 13c of the first wiring board 3a and the outer part 17c of the second wiring board 3b, and keep a clearance between the first and second wiring boards 3a and 3b at the clearance L1. Further, the ends of the electrode pieces 16 on the side of the first wiring board 3a are kept connected to the lands 18 of the terminal portions 19 on the second wiring board 3b.

After the rotor 1 and the stator 2 are stored in the casing body 4a, when the first and second wiring boards 3a and 3b connected via the spacers 21a and 21b are stored, leads 22 of the stator windings of the stator 2 are drawn from a space formed between an inner wall 23 of the casing body 4a and the outer part 13b of the first wiring board 3a and a space formed between the inner wall 23 of the casing body 4a and the outer part 17b of the second wiring board 3b. After the first and second wiring boards 3a and 3b are stored in the casing body 4a, the leads 22 of the stator windings are connected to the lands 15 on the undersurface of the first wiring board 3a through the guide grooves 20 of the second wiring board 3b and the guide grooves 14 of the first wiring board 3a as shown in FIGS. 1(a), 1(b), 5(a), and 5(d).

Before the connection is completed, the first and second wiring boards 3a and 3b are positioned and connected as follows:

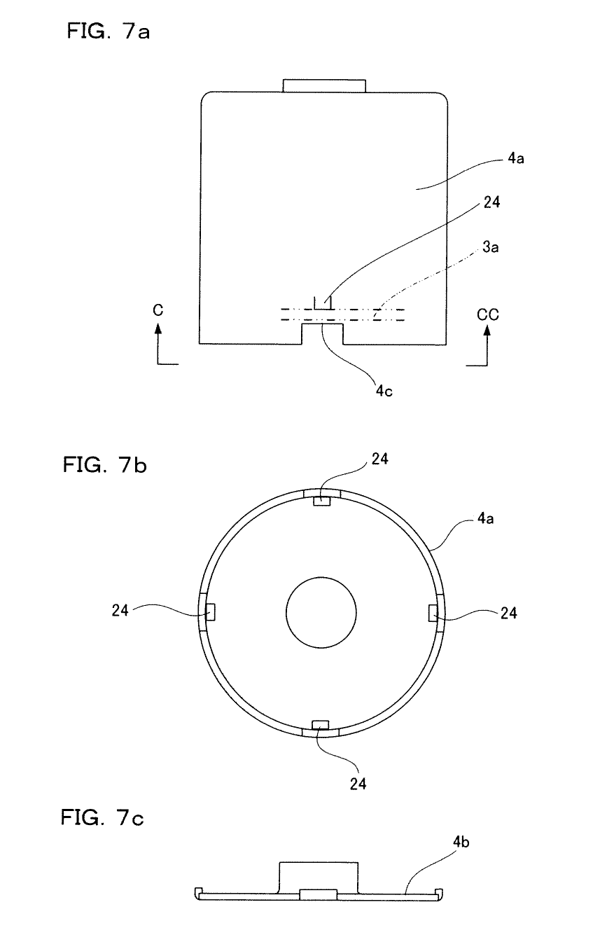

FIG. 7(a) shows the casing body 4a in this case. FIG. 7(b) shows the casing body 4a taken along line C-CC. FIG. 7(c) shows the casing lid 4b in this case. Cut-and-bent pieces 24 formed around the casing body 4a are bent to the inside of the casing body 4a, the outer periphery of the first wiring board 3a is received and supported by the ends of the cut-and-bent pieces 24 as shown in FIG. 6(b), the axial heights of the first and second wiring boards 3a and 3b are positioned, and the first and second wiring boards 3a and 3b are fixed by clamping ends 4c of the casing body 4a so as to correspond to the cut-and-bent pieces 24.

When the first and second wiring boards 3a and 3b are positioned and fixed by the cut-and-bent pieces 24, the leads 22 of the stator windings are connected to the lands 15 on the undersurface of the first wiring board 3a, and then the casing lid 4b is inserted into the casing body 4a and is fixed by clamping.

With this configuration, a detection signal and the like obtained by the magnetoelectric conversion elements 5 detecting the magnetic pole of the rotor 1 are inputted to the control circuit 6 of the first wiring board 3a from the second wiring board 3b through the electrode pieces 16, and the control circuit 6 switches power to the stator windings through the power elements 7, which are mounted on the first wiring board 3a, to generate a rotating magnetic field, and the rotor 1 is rotationally driven.

Further, even when a temperature increases to about 130° C. on the side of the rotor 1 and the stator 2 as has been discussed, it is possible to reduce a rise in temperature around the control circuit 6 and the power elements 7, which are mounted on the first wiring board 3a, as compared with the prior art. This is because the second wiring board 3b is disposed between the side of the rotor 1 and the stator 2 and the first wiring board 3a to interrupt the radiation and convection of heat in the present embodiment.

In this configuration, a signal from the control circuit 6 to the power elements 7 can be supplied through a through hole for connecting the top surface and the undersurface of the first wiring board 3a. Thus in the configuration of an inverter circuit for driving the motor, a driving circuit for the power elements can be disposed fairly close to the back sides of the power elements 7, so that pattern lengths can be made substantially uniform over the phases of the inverter with a short wiring distance. Therefore, when a high-speed switching element such as a MOSFET is used as a power element, a gate driving circuit can have substantially equal impedances in the respective phases and inductance components can be reduced, so that it can be expected that performance and reliability can be improved by a faster switching frequency.

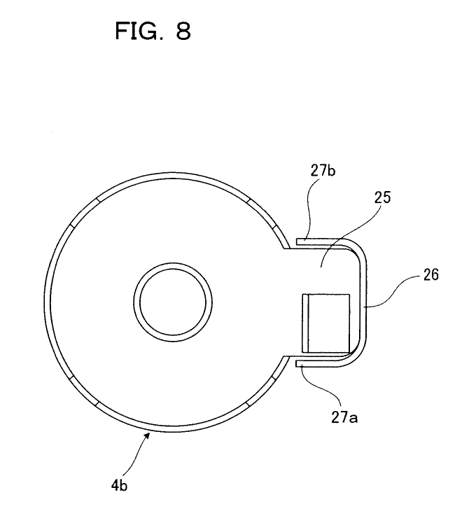

Further, to form a shield case for storing parts of the first and second wiring boards 3a and 3b protruding from the casing body 4a, the casing lid 4b of the present embodiment is shaped as follows: as shown in FIGS. 3 and 8, a shield case bottom 25 and a shield case side wall 26 are connected to each other and ends 27a and 27b of the shield case side wall 26 are drawn along the sides of the shield case bottom 25. Moreover, after the casing lid 4b is attached to the casing body 4a, an upper opening 28 of the shield case side wall 26 is closed by a metallic auxiliary lid 29.

The outer periphery of the first wiring board 3a is not entirely disposed close to the inner periphery of the casing body 4a and the outer parts 13a, 13b, and 13c of the first wiring board 3a are linearly cut so as to be separated from the inner wall of the casing body 4a, thereby reducing heat conduction from the casing body 4a to the first wiring board 3a.

### Second Embodiment

In the foregoing embodiment, the first and second wiring boards 3a and 3b are assembled by positioning the axial height of the first wiring board 3a with the cut-and-bent pieces 24 of the casing body 4a while keeping the clearance with the spacers 21a and 21b. The first and second wiring boards 3a and 3b can be assembled without using the spacers 21a and 21b.

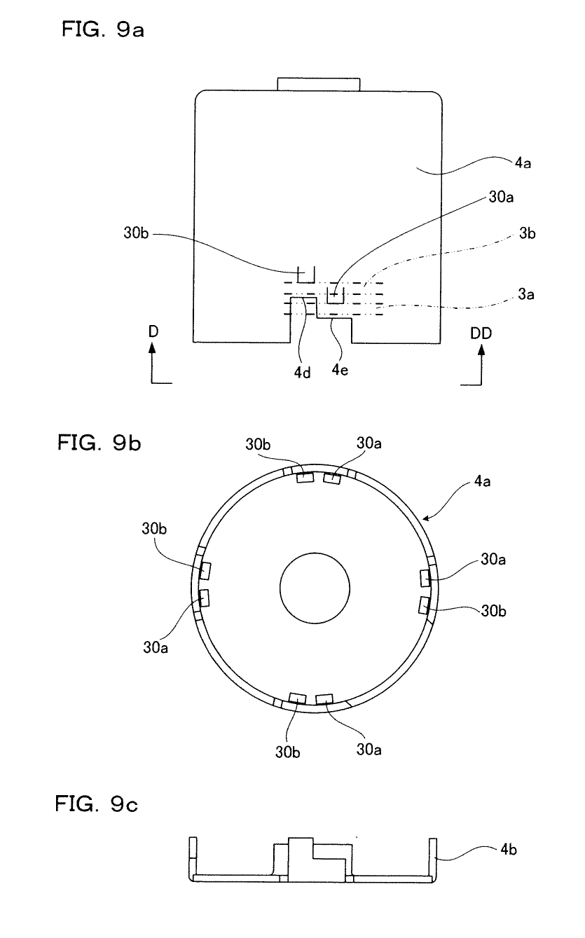

Referring to FIGS. 9(a), 9(b), and 9(c), a specific example will be described below.

FIG. 9(a) shows a casing body 4a in this case. FIG. 9(b) shows the casing body 4a taken along line D-DD. FIG. 9(c) shows a casing lid 4b in this case.

On the casing body 4a, second cut-and-bent pieces 30b for fixing a second wiring board 3b are formed in addition to first cut-and-bent pieces 30a for fixing a first wiring board 3a. The second wiring board 3b is inserted into the casing body 4a and the axial height of the second wiring board 3b is positioned by the second cut-and-bent pieces 30b; meanwhile, the second wiring board 3b is fixed by clamping ends 4d of the casing body 4a so as to correspond to the cut-and-bent pieces 30b. Next, the first wiring board 3a is inserted into the casing body 4a and the axial height of the first wiring board 3a is positioned by the first cut-and-bent pieces 30a; meanwhile, the first wiring board 3a is fixed by clamping ends 4e of the casing body 4a so as to correspond to the cut-and-bent pieces 30a. After that, the casing lid 4b is inserted into the casing body 4a and is fixed to the casing body 4a by clamping.

In the foregoing embodiments, the control circuit 6 and the power elements 7 are mounted on the first wiring board 3a, and the magnetoelectric conversion elements 5 are mounted on the second wiring board 3b. The power elements 7 may be mounted on the first wiring board 3a and the magnetoelectric conversion elements 5 and the control circuit 6 may be mounted on the second wiring board 3b.

In the foregoing embodiments, parts of the first and second wiring boards 3a and 3b protrude from the casing body 4a and the casing lid 4b is formed so as to shield the protruding parts. The present invention can be similarly implemented when the first and second wiring boards 3a and 3b are entirely stored in the casing body 4a.

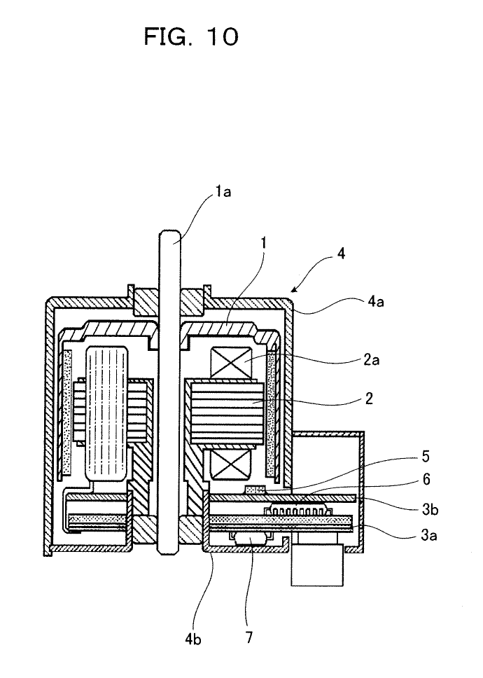

The foregoing embodiments described inner rotor types. The present invention can be similarly implemented by an outer rotor type shown in FIG. 10. In this configuration, the stator 2 is attached to the inner fixation side and the rotor 1 is rotatably supported on the outer periphery of the stator 2 on the same axis as the stator 2. In this case, the motor casing 4 covers the rotor 1 with a clearance from the outer periphery of the rotor 1. Heat conduction to the first wiring board 3a can be reduced by the second wiring board 3b partitioning the inside of the casing.

### INDUSTRIAL APPLICABILITY

The present invention can contribute to improvement in the reliability of various kinds of equipment using small sized brushless motors.

1. A brushless motor in which a magnetic pole of a rotor is detected by magnetoelectric conversion elements disposed on detection positions on a fixation side relative to the rotor, a control circuit switches power to a plurality of windings of a stator through power elements based on the detection to generate a rotating magnetic field, and the rotor is rotationally driven,
wherein the stator is disposed on a same axis as an output shaft of the rotor,
a first wiring board, on which at least the power elements are mounted out of the control circuit and the power elements, is disposed so as to be opposed to an opposite end of the output shaft of the rotor,
a second wiring board is disposed between the rotor and the first wiring board so as to partition an inside of a motor casing,
at least the magnetoelectric conversion elements out of the control circuit and the magnetoelectric conversion elements are disposed on the second wiring board in close vicinity to the rotor, and
the stator windings are connected to the first wiring board.

2. The brushless motor according to claim 1, wherein the control circuit is mounted on a surface of the first wiring board so as to face the second wiring board, and the power elements are mounted on an opposite surface of the first wiring board from the surface facing the second wiring board.

3. The brushless motor according to claim 1, wherein the first wiring board has a conductor disposed on a surface on which the power elements are mounted, and the conductor is larger in thickness than a conductor on a surface of the second wiring board, the surface having the magnetoelectric conversion elements mounted thereon.

4. The brushless motor according to claim 1, further comprising guide grooves formed on an outer periphery of the second wiring board, the guide grooves allowing passage of leads of the stator windings connected to the first wiring board from the stator.

5. The brushless motor according to claim 1, further comprising notches formed on parts of outer peripheries of the first and second wiring boards, and spacers fit between the notches of the first wiring board and an inner periphery of the motor casing to keep a clearance between the first wiring board and the second wiring board, the wiring boards being electrically connected to each other via electrode pieces passing through the spacers.
